(19) United States
(12) Patent Application Publication
(10) Pub. No.: US 2018/0355523 A1
(43) Pub. Date: Dec. 13, 2018

(54) Renewably Sourced Yarn and Method of Manufacturing Same

(71) Applicant: Mill Direct, Inc., Minnetonka, MN (US)

(72) Inventors: Dennis Lenz, Minnetonka, MN (US); Sri Lueth, Minnetonka, MN (US)

(73) Assignee: Mill Direct, Inc., Minnetonka, MN (US)

(21) Appl. No.: 16/103,881

(22) Filed: Aug. 14, 2018

Related U.S. Application Data
(63) Continuation-in-part of application No. 14/593,434, filed on Jan. 9, 2015.

(51) Int. Cl. D02G 3/04; D02G 3/44; D01F 6/62; D01D 5/26; D02G 1/20; D02G 1/10

(52) U.S. Cl. CPC D02G 3/042; D02G 3/449; D01F 6/625; B29C 47/0014; D02G 1/205; D02G 1/10; D01D 5/26

(57) ABSTRACT

A yarn includes a plurality of spun polylactic filaments. Silver particles are impregnated into the spun polylactic filaments to inhibit to growth of bacteria within the yarn. The yarn can be used to create fabric for any type of woven product.

This patent application is a continuation-in-part application of United States patent application having an application Ser. No. 14/593,434, filed Jan. 9, 2015, the disclosure of which is hereby incorporated by reference.

### BACKGROUND ART

### 1. Field of the Invention

The invention relates to yarn that is produced from a renewable source. More particularly, the invention relates to a yarn fabricated in manner to inhibit growth of bacteria thereon.

### 2. Description of the Related Art

Fabrics have been woven from many different materials, some of which are natural and some of which are synthetic. Wools and cottons are naturally occurring materials that are used to create yarn, which is woven into a fabric. Nylon, rayon, polyester and the like are synthetic materials capable of being produced in the form of a yarn for which the yarn may be woven into a fabric. While each of these materials used to create fabrics have different qualities and characteristics, each is valuable for particular styles and/or characteristics needed for a particular function of the fabric. For purposes of this disclosure, the fabrics may be used to create bedding, towels, clothing, blankets, banners, flags, sails, tarps and the like.

Until recently, man-made or synthetic filaments used to create yarns for fabric were all made from non-renewable resources, primarily petroleum. Use of petroleum to create fabrics is not desirable for several reasons. Some of these reasons include, but are not limited to, the reliance on imported petroleum, the depletion of petroleum, the performance of fabrics created by petroleum, and the disposal of these products after their useful life has expired.

Recently, a natural based filament, derived entirely from sustainable agricultural resources has been produced. This natural based filament is produced from the sugars created by any number of plants. The sugars are fermented and the fermented sugar is transformed into polylactide, a polymer. A common polylactide is sold under the trademark Ingeo™, produced by NatureWorks, LLC out of Minnetonka, Minn.

Products have been made from the Ingeo™ polylactide polymer. However, these fabrics are lacking in the refinement in that they are not capable of being produced at such a quality that would find mass appeal in the general market. Therefore, there is a need in the art for a synthetic yarn produced from a renewable source having the quality commensurate with that which is currently found in the marketplace to render the fabrics created by these synthetic yarns appealing the marketplace.

### SUMMARY OF THE INVENTION

A yarn includes a plurality of spun polylactic filaments. Silver particles are impregnated into the spun polylactic filaments to inhibit to growth of bacteria within the yarn.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a logic chart of one embodiment of the inventive method;

FIG. 2 is a perspective view of equipment used to draw extrusion lines;

FIG. 3 is a perspective view of equipment used to spin filament;

FIG. 4 is a perspective view of equipment used to crimp filaments;

FIG. 5 is a perspective view of equipment used to heat set the crimped filaments;

FIG. 6 is a cross-sectional view of a yarn incorporating one embodiment of the invention;

FIG. 7 is a side view, partially cut away, of a yarn being crimped according to one embodiment of the invention;

FIG. 8 is a graph comparing tenacity as a function of percentage of extension for various filaments; and

FIG. 9 is a table comparing various physical properties of filaments.

### DETAILED DESCRIPTION OF THE PREFERRED EMBODIMENT

Polylactide (PLA) resins are produced from renewable sources, namely plants that produce sugar in relatively high percentages. There are two types of PLA resins: D-enantiomers and L-enantiomers, that when combined, may form a stereoisomer. Unlike many commercial PLA resins, the PLA resin used in the invention disclosed herein only utilizes the D-enantiomer, to the exclusion of the L-enantiomer. The D-PLA resin is used because it is more suitable for thermal forming and less likely to crystallize during processing steps that include heating.

The method for manufacturing the yarn includes the use of a plurality of PLA pellets 10. In the preferred embodiment, the PLA pellets used include those produced by NatureWorks, LLC of Minnetonka, Minnesota under the trademark Ingeo™. In particular, the invention incorporates the use of Ingeo™ Biopolymer 6100D and the specifications for this product are set forth in NatureWorks, LLC Technical Data Sheet, the information of which is incorporated into this disclosure.

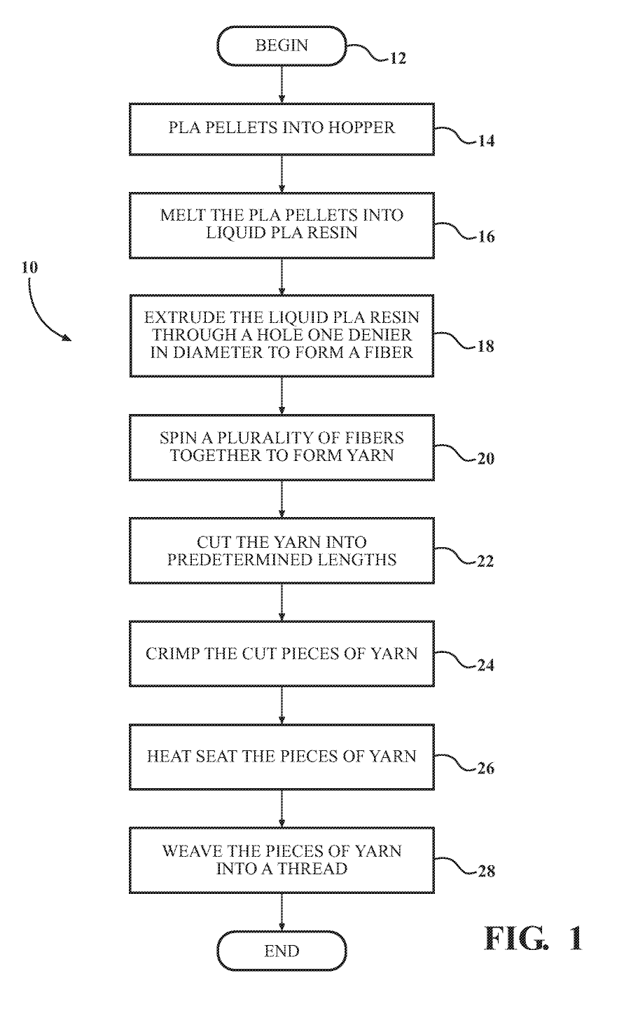

Referring to FIG. 1, a logic chart of one embodiment of the inventive method is generally indicated at 10. The method begins at 12. The method includes placing the plurality of PLA pellets into a hopper at 14. The PLA pellets are then melted to form liquid PLA resin at 16. In order to heat the PLA pellets allowing them to reach liquid PLA resin, the temperature in the hopper is raised in excess of 410° F. The liquid PLA resin 14 is then extruded through an opening to form a filament at 18. A plurality of these filaments are spun together to create yarn at 20.

One of the difficulties in using PLA resin to create yarn to be used in fabric is that the resulting yarn cannot be successfully woven into a fabric due to inconsistencies created by the filament. This characteristic of the filament is eliminated when the extrusion process includes extruding the liquid PLA resin through an opening having a diameter less than three denier wide, with a denier being defined as half of a micron in length. In a preferred embodiment, the diameter of the opening through which the PLA resin is extruded is approximately 1.0-1.1 denier in diameter. The opening through which the filament is extruded is circular in shape.

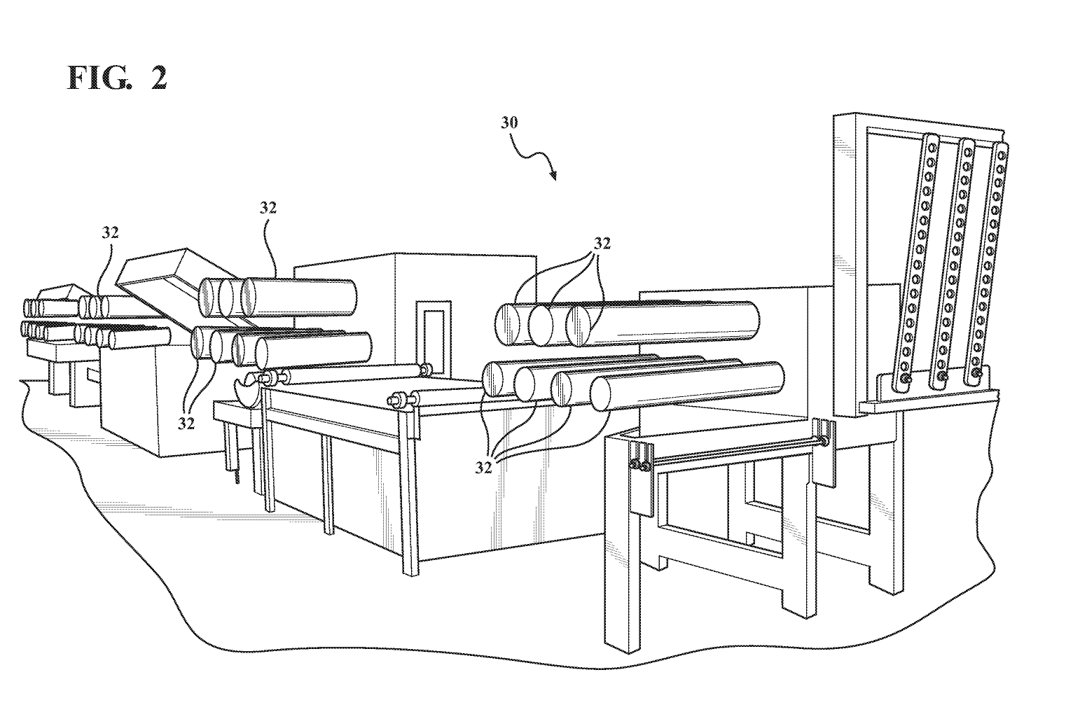

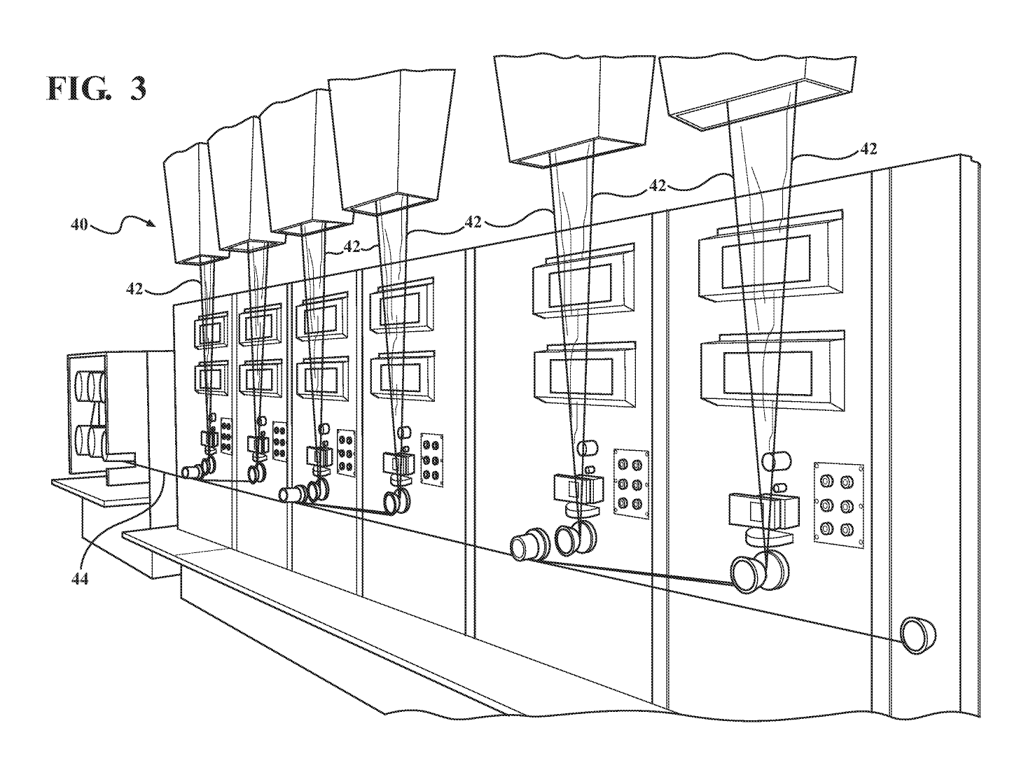

Referring to FIG. 2, a perspective view of equipment used to draw the filaments is generally shown at 30. Filaments are stretched and wrapped around rollers 32. In FIG. 3, a perspective view of equipment used to spin the filaments into yarn is generally shown at 40. The filaments 42 are passed over spindles 44 that combine filaments 42 for the combination of those filaments 42 into a yarn 44.

Immediately following the extrusion of the filament 18 from the hopper 12, the filament 18 is cooled. While a defined cooling process (air jet, reduced ambient temperature room, etc.) may be used to assist in certain circumstances, it is not contemplated that much assistance is needed as the filament is so thin, it rapidly cools once it leaves the hopper.

The filament is then cut to a predetermined length to create a plurality of cut filaments at 22. The predetermined length varies based on the type of fabric in which the yarn is going to be used. For example, if the yarn is going to be used for carpet or bedding sheets, the predetermined length will be approximately 38 millimeters. It may be appreciated by those skilled in the art that the variance in the predetermined length of the plurality of cut filaments are determined by the design of the fabric being produced.

Once a plurality of cut filaments have been created, each of the plurality of cut filaments is crimped at 24 using crimping equipment 50. This is graphically shown in FIG. 7 wherein a crimping tool 50 is shown creating a crimp 52 in a plurality of cut filaments 54 that make up a piece of yarn, generally shown at 56. The crimping of each of the plurality of cut filaments results in crimps 52 spaced apart from each other along the length of the cut filaments 54. The crimping is done multiple times for each piece of the plurality of cut filaments 54. In one embodiment, the cut filaments 54 include five crimps 52. In a preferred embodiment, the cut filaments 54 are crimped at least ten times per inch.

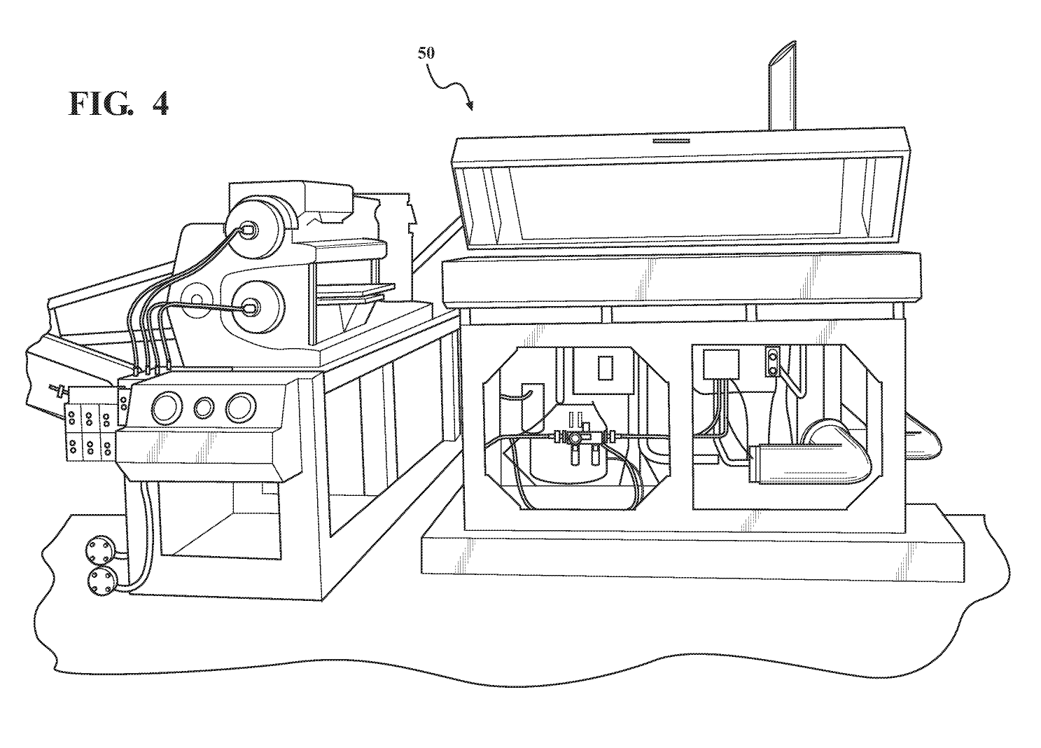

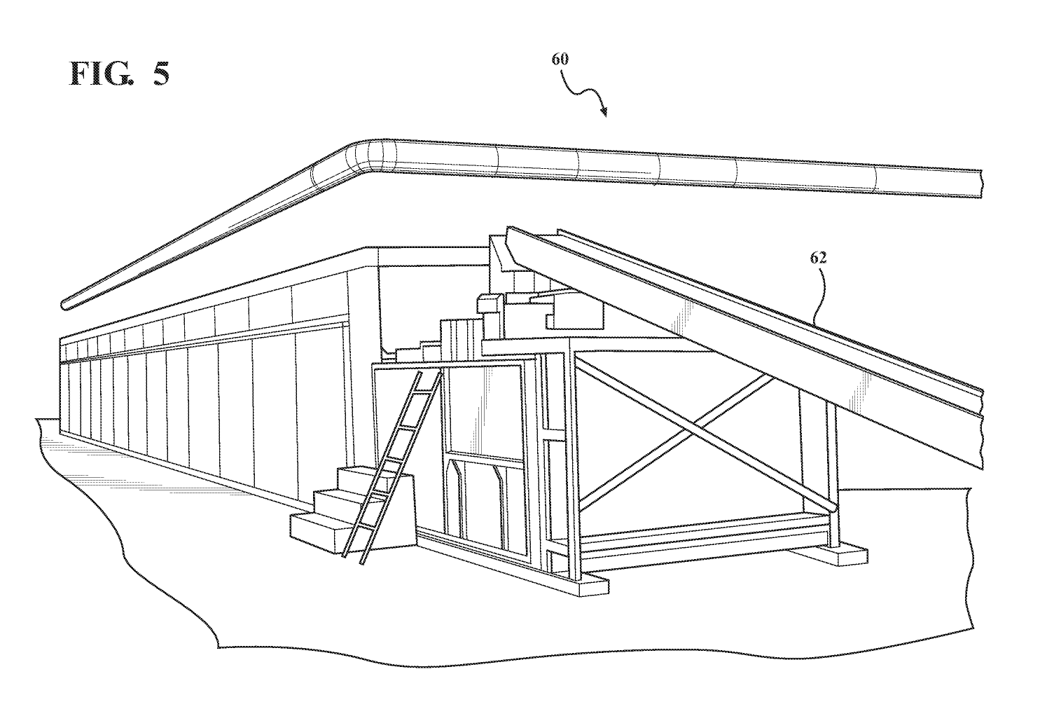

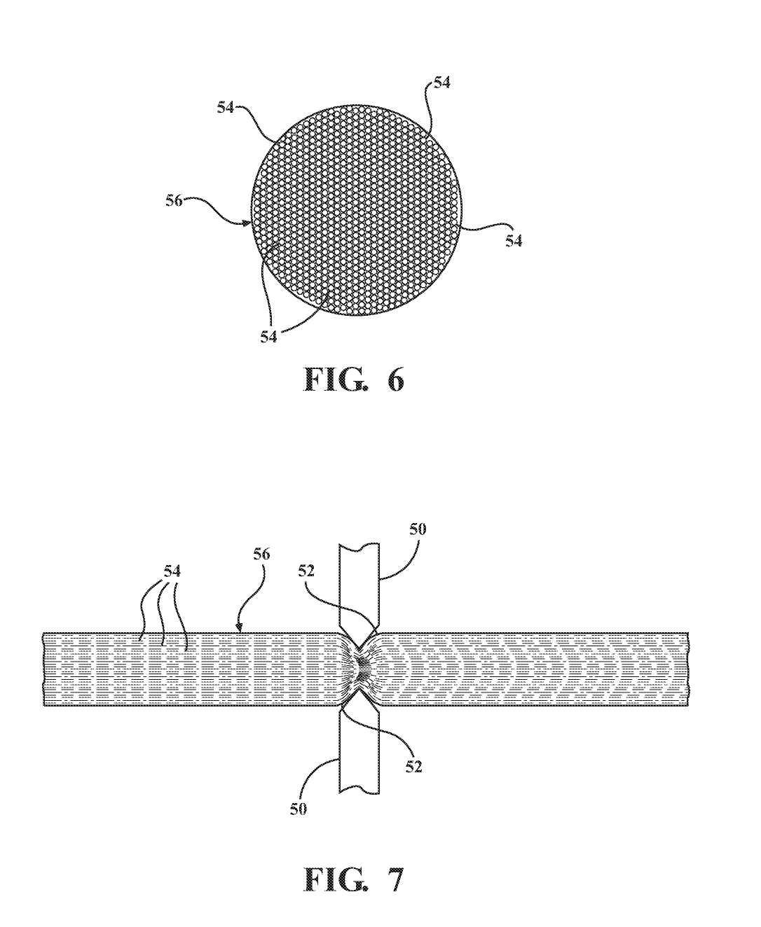

Once crimped using the crimping tool, graphically shown in FIG. 7 as 50 and generally shown in FIG. 4, the yarn is finally treated by a heat setting operation using equipment generally indicated at 60 in FIG. 5. The heat setting operation 26 (FIG. 1) receives the pieces of yarn into the heat setting equipment 60 via a conveyor 62. After the pieces of yarn are heat set, they are woven into thread at 28.

Filaments made from Ingeo™ are produced with 68% less energy than filaments produced using other synthetics. Less energy consumption translates into fewer greenhouse gases emitted into the atmosphere, which will lessen any adverse impact on the atmosphere by its production. The filaments are impregnated with silver through an ionization process. The resulting filaments have between 50 and 100 parts per million (ppm) silver content. In the preferred embodiment, the resulting filaments have 75 ppm silver content.

A yarn includes a plurality of spun polylactic filaments, silver ionized particles are impregnated into the spun polylactic filaments to inhabit and kill the growth of bacteria within the yarn. The yarn can be used to create fabric for any type of knit, woven or spun product.

When fabrics were produced with yarn fabricated with the silver impregnated Ingeo™ polylactic filaments, they were tested by simulating 75 and 100 home launderings after being exposed to Staphylococcus aureus in one test set and Klebsiella pneumoniae in a second test set. As compared with a control set of fabrics that were not impregnated with silver, and after having contact with these strains of bacteria for 24 hours, the fabrics fabricated with the silver impregnated Ingeo™ polylactic filaments were 99.9% free of the strain of bacteria being tested after initial exposure, after 75 washes, and after 100 washes. Testing showed the silver impregnated fabrics did not lose their ability to reduce bacteria even after 100 simulated launderings to an effectively eliminate the bacteria from the fabrics.

Fabrics that use the above-described yarn 56 have wicking properties superior to other synthetic materials. A test with strips of needle-punched non-woven fabric made with the yarn 56 was performed against fabric made from polyester (PET). The strips, machine direction (MD) and cross-machine direction (CD) were dipped into a glass filled with colored water to measure the movement of the water in the fabric. Measurements were taken at 5, 20, 30, 40, 60 and 120 minutes. The average wicking height, in inches after 120 minutes for the yarn 56 was 100% greater than that of the polyester in both unfinished and finished fabrics.

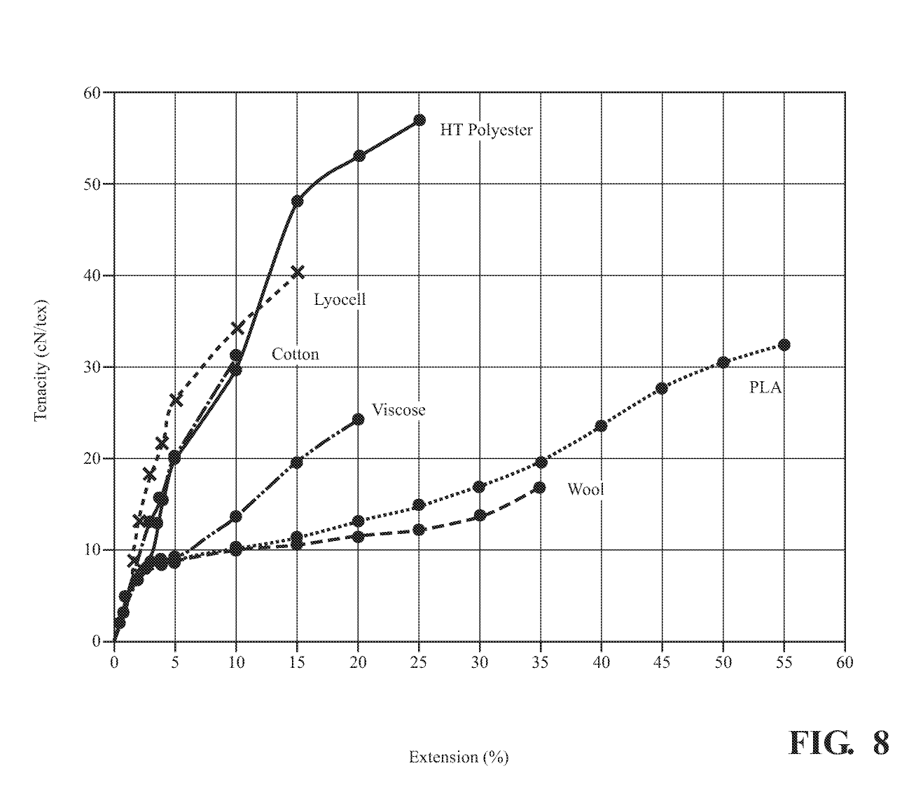

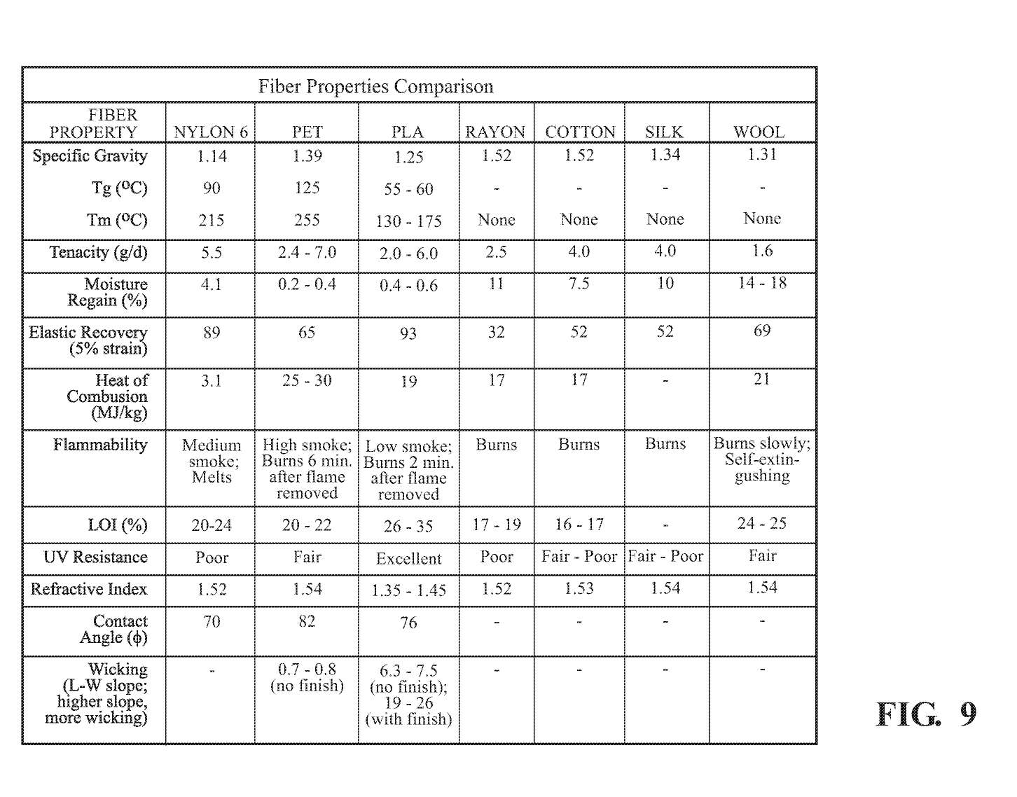

The fabric produced with the yarn 56 was also tested against various other natural fabrics to determine its relative strength. With 1.5 dtex 38 mm Ingeo™ PLA, the stress strain data set forth in FIG. 8 shows the yarn 56 is far superior relative strength due to its elongation properties as compared with the other nature fabrics tested.

Referring to FIG. 9, filament properties of several materials are compared with PLA filaments used to create the yarn 56. The PLA filaments consistently perform better over most categories. In particular, the elastic recovery (at 5% strain) of the PLA filaments is far superior to all other filaments tested. The limited oxygen index percentage (LOI %) is higher than all of the other filaments tested.

One product that is produced using the yarn 56 is a towel. 100% of the yarn 56 spun and woven to form the towel uses its excellent wicking properties to quickly remove moisture from the object being dried. The moisture is quickly released from the towel during light drying because the yarn 56 does not absorb the moisture.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

I claim:

1. A yarn comprising:
a plurality of spun polylactic filaments; and
silver particles impregnated into said plurality of spun polylactic filaments to inhibit to growth of bacteria within said yarn.

2. A yarn as set forth in claim 1 wherein each of the plurality of spun polylactic filaments has a diameter equal to or less than 3.0 denier.

3. A yarn as set forth in claim 2 wherein each of said plurality of spun polylactic filaments is less than 50 mm long.

4. A yarn as set forth in claim 3 wherein each of said plurality of spun polylactic filaments has a diameter less than 1.0 denier.

5. A yarn as set forth in claim 1 wherein said yarn is impregnated by said silver at a ratio of in a range of 50 to 100 parts per million silver.

6. A yarn as set forth in claim 1 wherein said yarn is impregnated by said silver at a ratio of 75 parts per million silver.
